(19) United States
(12) Patent Application Publication
(10) Pub. No.: US 2024/0429451 A1
(43) Pub. Date: Dec. 26, 2024

(54) BATTERY

(71) Applicant: ZHUHAI COSMX BATTERY CO., LTD., Zhuhai (CN)

(72) Inventors: Hai WANG, Zhuhai (CN); Feng WANG, Zhuhai (CN); Suli LI, Zhuhai (CN); Junyi LI, Zhuhai (CN)

(73) Assignee: ZHUHAI COSMX BATTERY CO., LTD., Zhuhai (CN)

(21) Appl. No.: 18/824,202

(22) Filed: Sep. 4, 2024

Related U.S. Application Data
(63) Continuation of application No. PCT/CN2023/079526, filed on Mar. 3, 2023.

(30) Foreign Application Priority Data
Mar. 21, 2022 (CN) 202210277133.8

(51) Int. Cl. H01M 10/0568; H01M 10/0525; H01M 10/0567; H01M 50/122

(52) U.S. Cl. CPC H01M 10/0568; H01M 10/0525; H01M 10/0567; H01M 50/122

(57) ABSTRACT

A battery includes a battery cell, an electrolyte solution, and an aluminum-plastic film. The aluminum-plastic film includes an upper film and a lower film disposed opposite to each other, the upper film and the lower film are connected to form an accommodating cavity, and the battery cell and the electrolyte solution are disposed in the accommodating cavity; and the electrolyte solution includes a non-aqueous organic solvent, an additive, and a lithium salt, where the lithium salt includes lithium hexafluorophosphate and lithium bis(fluorosulfonyl)imide. In embodiments of the present disclosure, lithium hexafluorophosphate and lithium bis(fluorosulfonyl)imide are used as lithium sources. Lithium bis(fluorosulfonyl)imide does not react with water to generate hydrofluoric acid, which can effectively reduce a content of hydrofluoric acid and slow down aging of a packaging film, thereby prolonging a service life of a battery.

### CROSS-REFERENCE TO RELATED APPLICATIONS

The present disclosure is a continuation of International Application No. PCT/CN2023/079526, filed on Mar. 3, 2023, which claims priority to Chinese Patent Application No. 202210277133.8, filed on Mar. 21, 2022. Both of the aforementioned applications are hereby incorporated by reference in their entireties.

### TECHNICAL FIELD

The present disclosure relates to the field of lithium-ion battery technologies, and specifically relates to a battery.

### BACKGROUND

Lithium-ion batteries are energy storage apparatuses having a high energy density and cycling performance, and are widely used in mobile electronic products, new energy vehicles, and other fields. Pouch lithium-ion batteries are a major type of lithium-ion batteries. In related technologies, pouch lithium-ion batteries are packaged by using aluminum-plastic films. However, an electrolyte solution in a lithium-ion battery contains lithium hexafluorophosphate (LiPF₆) that reacts with water vapor that penetrates into the lithium-ion battery to generate hydrofluoric acid (HF), which accelerates aging of an aluminum-plastic film and further shortens a service life of the lithium-ion battery.

It may be learned that there is a problem in related technologies that a lithium-ion battery has a short service life.

### SUMMARY

Embodiments of the present disclosure provide a battery to solve a problem in related technologies that a lithium-ion battery has a short service life.

To achieve the foregoing objective, an embodiment of the present disclosure provides a battery, including a battery cell, an electrolyte solution, and an aluminum-plastic film, where the aluminum-plastic film includes an upper film and a lower film disposed opposite to each other, the upper film and the lower film are connected to form an accommodating cavity, and the battery cell and the electrolyte solution are disposed in the accommodating cavity; and

the electrolyte solution includes a non-aqueous organic solvent, an additive, and a lithium salt, where the lithium salt includes lithium hexafluorophosphate and lithium bis(fluorosulfonyl)imide (LiFSI).

As an optional implementation, a sealing edge is formed at a position at which the upper film and the lower film are connected, the sealing edge includes a top sealing edge and a side sealing edge, and a relationship among a content of lithium hexafluorophosphate, a content of lithium bis(fluorosulfonyl)imide, a width of the top sealing edge, and a width of the side sealing edge is:

$$\frac{{A}_{1} - {A}_{2}}{min ( {W}_{1} , {W}_{2} )} ⩽ {x}_{1} ,$$

where A1 is a mass fraction of lithium hexafluorophosphate in the electrolyte solution, A2 is a mass fraction of lithium bis(fluorosulfonyl)imide in the electrolyte solution, W1 is the width of the top sealing edge, in a unit of mm, W2 is the width of the side sealing edge, in a unit of mm, and x1 is a constant not greater than 0.2.

In a relational expression of the present disclosure, only a numerical portion of each parameter rather than a unit portion participates in calculation. The foregoing relational expression is used as an example. In Example 1 of the present disclosure, the mass fraction A1 of lithium hexafluorophosphate in the electrolyte solution is 18%, the mass fraction A2 of lithium bis(fluorosulfonyl)imide in the electrolyte solution is 1%, the width W1 of the top sealing edge is 4 mm, the width W2 of the side sealing edge is 10 mm, and then

$$\frac{{A}_{1} - {A}_{2}}{min ( {W}_{1} , {W}_{2} )} = 0.0425 .$$

As an optional implementation, a relationship among the width of the top sealing edge, the width of the side sealing edge, and a minimum sealing strength of the sealing edge is:

$$L = {x}_{2} + {x}_{3} \times min ( {W}_{1} , {W}_{2} ) ,$$

where L is the minimum sealing strength of the sealing edge, in a unit of N/15 mm, x2 is 16.45, and x3 is 14.12.

As an optional implementation, a relationship among the content of lithium hexafluorophosphate, the content of lithium bis(fluorosulfonyl)imide, and a minimum sealing strength of the sealing edge is:

$$\frac{{A}_{1} - {A}_{2}}{L} ⩽ {x}_{4} ,$$

where x4 is a constant not greater than 0.006.

As an optional implementation, a relationship between a content of lithium hexafluorophosphate and a content of lithium bis(fluorosulfonyl)imide includes:

$${A}_{1} + {A}_{2} ⩾ {x}_{5} , and$$

$${A}_{1} - {A}_{2} ⩽ {x}_{6} ,$$

where x5 is 12%, and x6 is 17%.

As an optional implementation, the relationship between the content of lithium hexafluorophosphate and the content of lithium bis(fluorosulfonyl)imide further includes:

$$\frac{{A}_{2}}{{A}_{1}} ⩾ {x}_{7} ,$$

where x7 is 0.01.

As an optional implementation, A1 ranges from 0.1% to 30%, and A2 ranges from 0.1% to 30%.

As an optional implementation, W1 is not less than a preset value Y, and Y meets:

$$Y = \frac{( {x}_{8} + {x}_{9} \times H ) \times {W}_{2}}{{x}_{10} - {x}_{11} \times H + {W}_{2}} ,$$

where H is a thickness of the sealing edge, in a unit of μm, and x8, x9, x10, and x11 are all constants.

As an optional implementation, x8 ranges from 0.001 to 0.01, x9 ranges from 0.001 to 0.01, x10 ranges from 0.001 to 0.01, and x11 ranges from 0.001 to 0.01.

As an optional implementation, the additive includes styrene, and a mass fraction of styrene in the electrolyte solution ranges from 0.1% to 1%.

One of the foregoing technical solutions has the following advantages or beneficial effects:

In embodiments of the present disclosure, lithium hexafluorophosphate and lithium bis(fluorosulfonyl)imide are used as lithium sources. Lithium bis(fluorosulfonyl)imide does not react with water to generate hydrofluoric acid, which can effectively reduce a content of hydrofluoric acid and slow down aging of a packaging film, thereby prolonging a service life of a battery.

### BRIEF DESCRIPTION OF THE DRAWINGS

To describe technical solutions of embodiments of the present disclosure more clearly, the following briefly describes the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a schematic diagram of a structure of a battery according to an embodiment of the present disclosure.

FIG. 2 is a schematic diagram of a top sealing edge and a side sealing edge of a battery according to an embodiment of the present disclosure.

FIG. 3 is a diagram showing a relationship between a width of a sealing edge and a sealing strength according to an embodiment of the present disclosure.

FIG. 4 is a diagram showing a relationship between a width of a top sealing edge and a width of a side sealing edge according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts fall within the protection scope of the present disclosure.

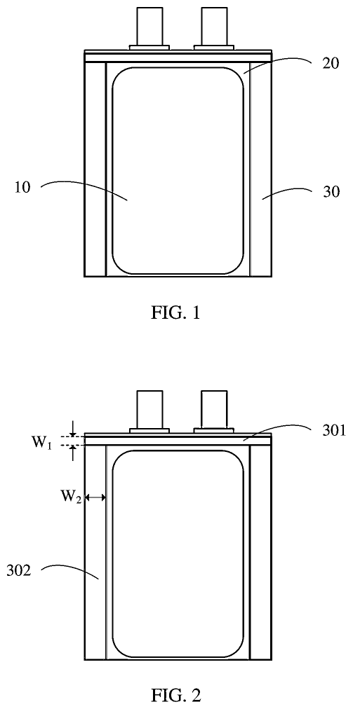

As shown in FIG. 1, an embodiment of the present disclosure provides a battery, including a battery cell 10, an electrolyte solution 20, and an aluminum-plastic film, where the aluminum-plastic film includes an upper film and a lower film disposed opposite to each other, the upper film and the lower film are connected to form an accommodating cavity, and the battery cell 10 and the electrolyte solution 20 are disposed in the accommodating cavity; and

the electrolyte solution 20 includes a non-aqueous organic solvent, an additive, and a lithium salt, where the lithium salt includes lithium hexafluorophosphate and lithium bis(fluorosulfonyl)imide.

In this embodiment, lithium hexafluorophosphate and lithium bis(fluorosulfonyl)imide are used as lithium sources at the same time for charge-discharge cycles. No side reaction occurs between lithium bis(fluorosulfonyl)imide and water to generate hydrofluoric acid, which can effectively reduce a content of hydrofluoric acid in a battery and slow down aging of a battery packaging film, thereby prolonging a service life of the battery. In contrast, although lithium hexafluorophosphate has excellent charge-discharge cycling performance, a side reaction occurs between lithium hexafluorophosphate and water as follows:

LiPF₆+2H₂O→LiPO₂F₂+4HF;

LiPF₆→LiF+PF₅; and

PF₅+H₂O→POF₃+2HF.

After the foregoing side reaction occurs, hydrofluoric acid is generated in the battery, which corrodes the aluminum-plastic film of the battery and accelerates aging of the aluminum-plastic film. In addition, the generation of hydrofluoric acid may increase a pressure inside the battery, causing packaging of the aluminum-plastic film of the battery to be subjected to tensile stress. Excessive tensile stress may cause the battery to fail.

Moreover, the aluminum-plastic film includes an outer layer, an intermediate layer, and an inner layer. The outer layer is polyamide, polyethylene terephthalate, or a compound including polyamide and polyethylene terephthalate, the intermediate layer is an aluminum material, and the inner layer is polypropylene or a modified compound including polypropylene. In a packaging process, inner layers of the upper film and the lower film are melted into one layer for packaging and fixing, but a side reaction is prone to occur between a material of the inner layers and the electrolyte solution 20 to generate hydrofluoric acid causing corrosion. This causes the aluminum-plastic film of the battery to age faster and reduce a life of the battery.

In order to effectively reduce a content of hydrofluoric acid that may be generated, in this embodiment of the present disclosure, lithium bis(fluorosulfonyl)imide is used as a lithium source to replace part of lithium hexafluorophosphate. This can effectively reduce the hydrofluoric acid that may be generated. In addition, a combination of lithium bis(fluorosulfonyl)imide and lithium hexafluorophosphate is also used to form a passivation protective film on a surface of the aluminum-plastic film. This further reduces a corrosion effect of hydrofluoric acid on the aluminum-plastic film and prolongs a service life of the battery.

As an optional implementation, as shown in FIG. 1 and FIG. 2, a sealing edge 30 is formed at a position at which the upper film and the lower film are connected, the sealing edge 30 includes a top sealing edge 301 and a side sealing edge 302, and a relationship among a content of lithium hexafluorophosphate, a content of lithium bis(fluorosulfonyl)imide, a width of the top sealing edge 301, and a width of the side sealing edge 302 is:

$$\frac{{A}_{1} - {A}_{2}}{min ( {W}_{1} , {W}_{2} )} \leq {x}_{1} ,$$

where A₁ is a mass fraction of lithium hexafluorophosphate in the electrolyte solution 20, A₂ is a mass fraction of lithium bis(fluorosulfonyl)imide in the electrolyte solution 20, W₁ is the width of the top sealing edge 301, W₂ is the width of the side sealing edge 302, and x₁ is a constant not greater than 0.2.

As an optional implementation, x₁ is a constant not greater than 0.05.

In this embodiment, different contents of hydrofluoric acid may be generated with different contents of lithium bis(fluorosulfonyl)imide and lithium hexafluorophosphate, and design requirements for the width of the top sealing edge 301 and the width of the side sealing edge 302 are also inconsistent. When the content of lithium hexafluorophosphate is small, the content of hydrofluoric acid generated is small, and the width of the top sealing edge 301 and the width of the side sealing edge 302 may be designed to be small. When the content of lithium hexafluorophosphate is large, the content of hydrofluoric acid generated is large, and the width of the top sealing edge 301 and the width of the side sealing edge 302 may be designed to be large. Therefore, in this embodiment of the present disclosure, if conditions are met, the battery can be used normally within a designed life of 15 years.

Herein, A₁ and A₂ are in a unit of a mass percentage (that is %), and W₁ and W₂ are in a unit of mm.

As an optional implementation, a relationship among the width of the top sealing edge 301, the width of the side sealing edge 302, and a minimum sealing strength of the sealing edge 30 is:

$$L = {x}_{2} + {x}_{3} \times min ( {W}_{1} , {W}_{2} ) ,$$

where L is the minimum sealing strength of the sealing edge 30, x₂ is 16.45, and x₃ is 14.12.

In the present disclosure, the minimum sealing strength of the sealing edge may be obtained by the following method. Specifically, two aluminum-plastic films are bonded together by hot pressing and cut into rectangles with a width of 15 mm in a sealing direction, and then a tensile machine is used to test a tensile force required to separate the two aluminum-plastic films bonded together.

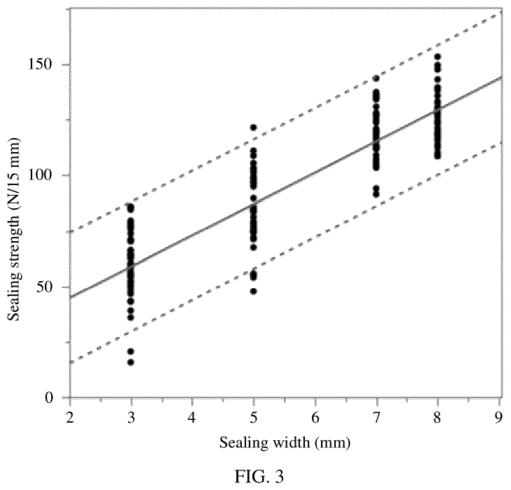

In this embodiment, there is an approximately linear relationship between a sealing strength and a sealing width. However, since there is a specific processing error in the sealing width in an engineering process, optimal contents of lithium hexafluorophosphate and lithium bis(fluorosulfonyl)imide may be better analyzed through the sealing strength. As shown in FIG. 3, the relationship between the sealing strength and the sealing width is obtained through experimental fitting, where an area between two dashed lines is 95% confidence intervals, and goodness of fit R2=0.8. It may be learned from the figure that the relationship between the sealing strength and the sealing width is shown in the foregoing formula.

L is in a unit of N/15 mm.

As an optional implementation, a relationship among the content of lithium hexafluorophosphate, the content of lithium bis(fluorosulfonyl)imide, and a minimum sealing strength of the sealing edge 30 is:

$$\frac{{A}_{1} - {A}_{2}}{L} \leq {x}_{4} ,$$

where x₄ is a constant not greater than 0.006.

As an optional implementation, x₄ is a constant not greater than 0.003.

In this embodiment, different contents of hydrofluoric acid may be generated with different contents of lithium bis(fluorosulfonyl)imide and lithium hexafluorophosphate, and design requirements for the width of the top sealing edge 301 and a sealing strength of the side sealing edge 302 are also inconsistent. When the content of lithium hexafluorophosphate is small, the content of hydrofluoric acid generated is small, and the width of the top sealing edge 301, the width of the side sealing edge 302, a sealing strength of the top sealing edge 301, and the sealing strength of the side sealing edge 302 may be small. When the content of lithium hexafluorophosphate is large, the content of hydrofluoric acid generated is large, and the width of the top sealing edge 301, the width of the side sealing edge 302, the sealing strength of the top sealing edge 301, and the sealing strength of the side sealing edge 302 may be large. Therefore, in this embodiment of the present disclosure, if conditions are met, the battery can be used normally within a designed life of 15 years.

As an optional implementation, a relationship between a content of lithium hexafluorophosphate and a content of lithium bis(fluorosulfonyl)imide includes:

$${A}_{1} + {A}_{2} \geq {x}_{5} , and$$

$${A}_{1} - {A}_{2} \leq {x}_{6} ,$$

where x₅ is 12%, and x₆ is 17%.

In this embodiment, since lithium sources used for charge-discharge cycles of the battery are mainly lithium hexafluorophosphate and lithium bis(fluorosulfonyl)imide, in order to ensure a charge-discharge cycling performance of the battery, a mass fraction of the lithium sources in the battery, that is, lithium hexafluorophosphate and lithium bis(fluorosulfonyl)imide, in the electrolyte solution 20 is not less than 12%. In this case, lithium ions in the electrolyte solution 20 can maintain the charge-discharge cycling performance of the battery at a high level.

In addition, while maintaining the charge-discharge cycling performance of the battery at a high level, due to high conductivity and wide electrochemical stability window of lithium hexafluorophosphate and processing difficulty and high price of lithium bis(fluorosulfonyl)imide, it is required to limit the contents of lithium hexafluorophosphate and lithium bis(fluorosulfonyl)imide, to effectively control generation of hydrofluoric acid while controlling use of lithium bis(fluorosulfonyl)imide. In this embodiment of the present disclosure, experimental tests have shown that an optimal range of a difference between the mass fraction of lithium hexafluorophosphate and the mass fraction of lithium bis(fluorosulfonyl)imide in the electrolyte solution 20 is not greater than 17%.

As an optional implementation, the relationship between the content of lithium hexafluorophosphate and the content of lithium bis(fluorosulfonyl)imide further includes:

$$\frac{{A}_{2}}{{A}_{1}} \geq {x}_{7} ,$$

where x₇ is 0.01.

In this embodiment, lithium hexafluorophosphate has high ionic conductivity and a stable electrochemical window, and lithium bis(fluorosulfonyl)imide can effectively improve a problem that lithium hexafluorophosphate is prone to thermal decomposition. Through mixing of lithium hexafluorophosphate and lithium bis(fluorosulfonyl)imide, the content of hydrofluoric acid generated can be effectively reduced while maintaining high charge-discharge cycling performance, thereby prolonging a service life of the battery. A mass ratio of lithium bis(fluorosulfonyl)imide to lithium hexafluorophosphate obtained through experiments in this embodiment of the present disclosure is not less than 0.01.

As an optional implementation, A₁ ranges from 0.1% to 30% (for example, 0.1%, 0.5%, 1%, 5%, 10%, 15%, 20%, 25%, or 30%), and A₂ ranges from 0.1% to 30% (for example, 0.1%, 0.5%, 1%, 5%, 10%, 15%, 20%, 25%, or 30%).

In this embodiment, since the charge-discharge cycling performance of the battery is related to a content of lithium ions, in order to maintain the charge-discharge cycling performance of the battery at a high level, the mass fraction of lithium hexafluorophosphate as a lithium source in the electrolyte solution 20 ranges from 0.1% to 30%, and the mass fraction of lithium bis(fluorosulfonyl)imide in the electrolyte solution 20 ranges from 0.1% to 30%.

Specifically, when the contents of lithium hexafluorophosphate and lithium bis(fluorosulfonyl)imide in the electrolyte solution 20 are too small, lithium ions in the electrolyte solution 20 are small, which may lead to a decrease in the charge-discharge cycling performance of the battery; if the content of lithium hexafluorophosphate in the electrolyte solution 20 is too large, lithium hexafluorophosphate may still react with water to generate a large amount of hydrofluoric acid, causing the aluminum-plastic film to age faster and the service life of the battery to decrease. In this embodiment of the present disclosure, after experimental tests, an optimal range of a mass ratio of lithium hexafluorophosphate to the electrolyte solution 20 ranges from 0.1% to 30%, and an optimal range of a mass ratio of lithium bis(fluorosulfonyl)imide to the electrolyte solution 20 ranges from 0.1% to 30%.

As an optional implementation, W₁ is not less than a preset value Y, and Y meets:

$$Y = \frac{( {x}_{8} + {x}_{9} \times H ) \times {W}_{2}}{{x}_{10} - {x}_{11} \times H + {W}_{2}} ,$$

where H is a thickness of the sealing edge 30 (including the top sealing edge 301 and the side sealing edge 302), in a unit of μm, and x₈, x₉, x₁₀, and x₁₁ are all constants.

In this embodiment, during use of the battery, water vapor can penetrate into an interior of the battery through the inner layers of the top sealing edge 301 and the side sealing edge 302, and react with lithium hexafluorophosphate in the electrolyte solution 20 to generate hydrofluoric acid. When designing the width of the top sealing edge 301 and the width of the side sealing edge 302, it is required to reduce a possibility of water vapor entering the interior of the battery as much as possible while saving materials. In this embodiment of the present disclosure, experimental tests have shown that when the width of the top sealing edge 301 and the width of the side sealing edge 302 meet the foregoing conditions, the battery can be used safely within the designed life.

The foregoing formula reflects a correlation between the width of the top sealing edge and the width of the side sealing edge. When a thickness value of the sealing edge 30 is determined, the preset value obtained is different based on a different width value of the side sealing edge 302. Therefore, a preset value corresponding to a width value of each side sealing edge 302 is calculated according to the formula, so that a boundary curve of the width of the top sealing edge under different thicknesses of the sealing edge can be obtained.

A thickness of the aluminum-plastic film used for packaging usually ranges from 210 μm to 270 μm, and therefore, in this embodiment of the present disclosure, an aluminum-plastic film with a thickness of 250 μm is selected for packaging. Through experimental tests, with the designed life of 15 years, the width of the top sealing edge 301 that can be effectively packaged is not less than 0.8 mm, and the width of the side sealing edge 302 that can be effectively packaged is not less than 4.1 mm. In addition, the width of the top sealing edge 301 and the width of the side sealing edge 302 cannot be increased indefinitely, and therefore, the width of the top sealing edge 301 and the width of the side sealing edge 302 of the battery need to be limited to achieve process feasibility and save materials. Therefore, in this embodiment of the present disclosure, the width of the top sealing edge 301 is designed to be ranging from 0.8 mm to 10 mm (for example, 0.8 mm, 0.9 mm, 1 mm, 2 mm, 3 mm, 4 mm, 5 mm, 6 mm, 7 mm, 8 mm, 9 mm, or 10 mm), and the width of the side sealing edge 302 is designed to be ranging from 4.1 mm to 10 mm (for example, 4.1 mm, 4.5 mm, 5 mm, 6 mm, 7 mm, 8 mm, 9 mm, or 10 mm), which can effectively perform packaging within the designed life of 15 years.

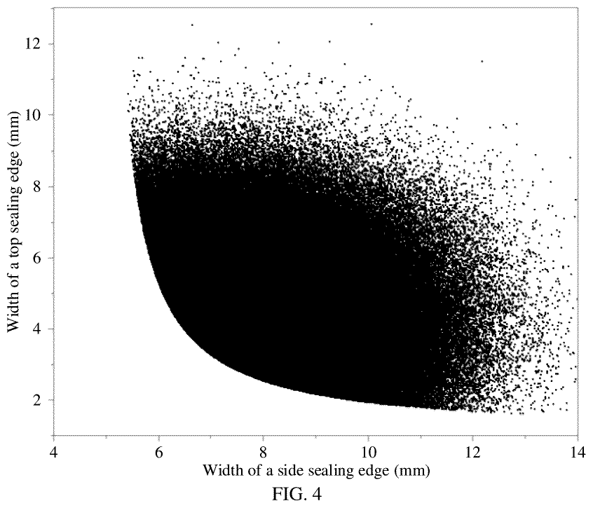

The width of the top sealing edge 301 is a top seal width, and the width of the side sealing edge 302 is a side seal width. As shown in FIG. 4, it may be learned that when the top seal width is not less than 0.8 mm and the side seal width is not less than 4.1 mm, the battery can be safely used within the designed life (15 years).

As an optional implementation, x₈ ranges from 0.001 to 0.01, (for example, 0.001, 0.002, 0.003, 0.004, 0.005, 0.006, 0.007, 0.008, 0.009, or 0.01), x₉ ranges from 0.001 to 0.01 (for example, 0.001, 0.002, 0.003, 0.004, 0.005, 0.006, 0.007, 0.008, 0.009, or 0.01), x₁₀ ranges from 0.001 to 0.01 (for example, 0.001, 0.002, 0.003, 0.004, 0.005, 0.006, 0.007, 0.008, 0.009, or 0.01), and x₁₁ ranges from 0.001 to 0.01 (for example, 0.001, 0.002, 0.003, 0.004, 0.005, 0.006, 0.007, 0.008, 0.009, or 0.01).

In this embodiment, values of x₈, x₉, x₁₀, and x₁₁ are not limited. For example, in some embodiments, x₈ ranges from 0.001 to 0.01, x₉ ranges from 0.001 to 0.01, x₁₀ ranges from 0.001 to 0.01, and x₁₁ ranges from 0.001 to 0.01. Further, through experimental tests of this embodiment of the present disclosure, a relationship curve between the top sealing edge 301 and the side sealing edge 302 that can meet an expected life can be obtained. A fitted curve shown in FIG. 4 is:

$$Y = \frac{( 0.0092721 + 0.0039685 \times H ) \times {W}_{2}}{0.0062564 - 0.0194843 \times H + {W}_{2}} .$$

In the formula, a value of x₈ is 0.0092721, a value of x₉ is 0.0039685, a value of x₁₀ is 0.0062564, and a value of x₁₁ is 0.0194843. When the foregoing formula is met, the service life can reach an expected target.

As an optional implementation, the additive includes styrene, and a mass fraction of styrene in the electrolyte solution 20 ranges from 0.1% to 1% (for example, 0.1%, 0.2%, 0.3%, 0.4%, 0.5%, 0.6%, 0.7%, 0.8%, 0.9%, or 1%).

In this embodiment, the styrene can react with the aluminum-plastic film, and molecules of the styrene gather on a surface of the aluminum-plastic film and a polymerization reaction takes place on the surface of the aluminum-plastic film, thereby enhancing a packaging effect of the aluminum-plastic film, improving cycling performance and storage performance of the battery, and prolonging the service life of the battery.

In this embodiment of the present disclosure, batteries with different parameters are tested through experiments, and the test steps are as follows:

Preparation of a positive electrode plate of a battery: A positive electrode active material LiNi_{0.5}Co_{0.2}Mn_{0.3}O₂, a binder polyvinylidene fluoride (PVDF), and a conductive agent acetylene black were mixed at a weight ratio of 97:1.5:1.5, and N-methylpyrrolidone (NMP) was added. A resulting mixture was stirred under action of a vacuum mixer until a mixed system became a positive electrode slurry with uniform fluidity. The positive electrode slurry was evenly applied on an aluminum foil having a thickness of 12 μm. The coated aluminum foil was baked in a five-stage oven with different temperatures and then dried in an oven at 120° C. for 8 hours, followed by rolling and cutting, to obtain the required positive electrode plate.

Preparation of a negative electrode plate of a battery: A negative electrode active material artificial graphite, a thickener sodium carboxymethyl cellulose (CMC-Na), a binder styrene-butadiene rubber, and a conductive agent acetylene black were mixed at a weight ratio of 97:1:1:1, and deionized water was added. A resulting mixture was stirred under action of a vacuum mixer to obtain a negative electrode slurry. The negative electrode slurry was evenly applied on a copper foil having a thickness of 8 μm. The coated copper foil was dried at room temperature, and then transferred to an oven at 80° C. for 10 hours for drying, followed by cold pressing and cutting, to obtain the required negative electrode plate.

Preparation of an electrolyte solution: In a glove box filled with argon gas and with qualified water and oxygen contents (water content<1 ppm, oxygen content<1 ppm), ethylene carbonate, ethyl methyl carbonate, and diethyl carbonate were evenly mixed at a mass ratio of 30:50:20 to form a mixed solvent, and then lithium salts with different content ratios were added to the mixed solvent, and the contents of the lithium salts were based on a total mass of the electrolyte solution. The mixture was stirred until the mixture was completely dissolved, and the required electrolyte solution was obtained after passing water content and free acid tests.

### Preparation of a Battery: Preparation of a Lithium-Ion Battery

The positive electrode plate, the separator (polyethylene film), and the negative electrode plate were sequentially stacked to ensure that the separator was located between the positive electrode plate and the negative electrode plate for separation, and then winding was performed to obtain a bare cell without liquid injection. The bare cell was placed in outer packaging foil with different parameters, the prepared electrolyte solution was injected into the dried bare cell, and after processes such as vacuum packaging, standing, forming, shaping, and sorting, the required pouch lithium-ion battery was obtained.

Examples and comparative examples with different parameters in the following table were prepared by the foregoing steps:

| | Content of lithium | | Top sealing | Side sealing | |
|---|---|---|---|---|---|
| | salt | | edge | edge | |
| Sequence number | LiFSI (A₂) | LiPF₆ (A₁) | width W₁ (mm) | width W₂ (mm) | $\frac{{A}_{1} - {A}_{2}}{min ( {W}_{1} , {W}_{2} )}$ |
| Comparative | 0% | 18% | 0.8 | 10 | 0.225 |
| Example 1 | | | | | |
| Comparative | 1% | 18% | 0.8 | 10 | 0.2125 |
| Example 2 | | | | | |
| Example 1 | 1% | 18% | 4 | 10 | 0.0425 |
| Example 2 | 4% | 12% | 4 | 10 | 0.02 |
| Example 3 | 10% | 5% | 4 | 10 | −0.0125 |

The following tests were performed on different comparative examples and examples:

High-temperature storage test: The batteries obtained in examples and comparative examples were charged and discharged five times at a charge-discharge rate of 1C at room temperature, and then charged to 4.2 V at a rate of 1C (with a cut-off current of 0.02C). A 1C capacity Q and a battery thickness T were recorded respectively. After the fully charged battery was stored at 60° C. for 30 days, a battery thickness T0 and a 1C discharge capacity Q1 were recorded. The battery was then charged and discharged at a rate of 1C at room temperature for five cycles, and a 1C discharge capacity Q2 was recorded. Experimental data such as a capacity retention rate, a capacity recovery rate, and a thickness change rate of the battery stored at a high temperature were obtained through calculation.

The calculation formulas used are as follows: Capacity retention rate (%)=Q1/Q×100%. Capacity recovery rate (%)=Q2/Q×100%. Thickness change rate (%)=(T0−T)/T×100%.

Cycling performance test: The batteries obtained in examples and comparative examples were charged and discharged for 200 cycles at 25° C. at a rate of 1C, with a charge/discharge voltage ranging from 3.0 V to 4.2 V. At the same time, a capacity of the 200th cycle was divided by a capacity of the first cycle to obtain a cycling capacity retention rate.

Results of the tests on different comparative examples and examples were shown in the following table:

| | Storage at 60° C. | | |
|---|---|---|---|
| Sequence | Thickness | Capacity | Capacity |
| number | expansion rate | retention rate | recovery rate |
| Comparative | 38.70% | 25.35% | 31.20% |
| Example 1 | | | |
| Comparative | 30.75% | 24.65% | 30.12% |
| Example 2 | | | |
| Example 1 | 15.80% | 56.86% | 60.63% |
| Example 2 | 17.70% | 55.35% | 61.20% |
| Example 3 | 18.75% | 54.35% | 60.72% |

It may be learned from the test results that addition of lithium bis(fluorosulfonyl)imide could effectively reduce a thickness expansion rate of the battery. In addition, the capacity retention rate and the capacity recovery rate of the battery were also high, which could effectively prolong a service life of the battery.

In addition, comparative examples and examples in which styrene was added were designed for experimental design, and parameter conditions were as follows:

| | | | | Top | Side | |
|---|---|---|---|---|---|---|
| | Content of | | | sealing | sealing | |
| | lithium salt | | Content | edge | edge | |
| Sequence number | LiFSI (A₂) | LiPF₆ (A₁) | of styrene | width W₁ (mm) | width W₂ (mm) | $\frac{{A}_{1} - {A}_{2}}{min ( {W}_{1} , {W}_{2} )}$ |
| Comparative | 4% | 5% | — | 4 | 10 | 0.0025 |
| Example 3 | | | | | | |
| Example 2 | 4% | 12% | — | 4 | 10 | 0.02 |
| Example 5 | 4% | 12% | 0.5% | 4 | 10 | 0.02 |

The high temperature storage test and cycling performance tests were performed on different comparative examples and embodiments, and the test results were as follows:

| | Capacity | | | |
|---|---|---|---|---|
| | retention | Storage at 60° C. | | |
| | rate after | Thickness | Capacity | Capacity |
| Sequence | 200 cycles | expansion | retention | recovery |
| number | at 25° C. | rate | rate | rate |
| Comparative | 46.78% | 18.70% | 51.43% | 61.38% |
| Example 3 | | | | |
| Example 2 | 76.81% | 17.70% | 55.35% | 61.20% |
| Example 5 | 92.76% | 0.80% | 76.86% | 90.63% |

It may be learned from the test results that adding styrene to the electrolyte solution could effectively improve the cycling performance of the battery, reduce the thickness expansion rate of the battery, and increase the capacity retention rate and the capacity recovery rate of the battery, thereby effectively prolonging the service life of the battery.

Similarly, a control experiment was conducted on parameters of different sealing strengths, and experimental conditions were shown in the following table:

| | Content of | | Minimum | | |
|---|---|---|---|---|---|
| | lithium salt | | sealing edge | | |
| Sequence number | LiFSI (A₂) | LiPF₆ (A₁) | width W₁ (mm) | Sealing strength | $\frac{{A}_{1} - {A}_{2}}{L}$ |
| Comparative | 0% | 18% | 0.8 | 27.746 | 0.006487422 |
| Example 1 | | | | | |
| Comparative | 1% | 18% | 0.8 | 27.746 | 0.006127009 |
| Example 2 | | | | | |
| Example 1 | 1% | 18% | 4 | 72.93 | 0.002331002 |
| Example 2 | 4% | 12% | 4 | 72.93 | 0.001096942 |
| Example 3 | 10% | 5% | 4 | 72.93 | −0.000685589 |

High temperature storage tests were performed on the examples and comparative examples in the foregoing table, and results are shown in the following table:

| | Storage at 60° C. | | |
|---|---|---|---|
| Sequence | Thickness | Capacity | Capacity |
| number | expansion rate | retention rate | recovery rate |
| Comparative | 38.70% | 25.35% | 31.20% |
| Example 1 | | | |
| Comparative | 30.75% | 24.65% | 30.12% |
| Example 2 | | | |
| Example 1 | 15.80% | 56.86% | 60.63% |
| Example 2 | 17.70% | 55.35% | 61.20% |
| Example 3 | 18.75% | 54.35% | 60.72% |

It may be learned from the foregoing table that for the sealing strength and the lithium salt content within the protection scope of the present disclosure, the life was greatly improved.

It should be noted that the implementation of the foregoing lithium-ion battery embodiment is also applicable to the embodiment of a electronic device including the lithium-ion battery and can achieve the same technical effect, and details are not described herein again.

It should be noted that, as used herein, terms “include”, “contain”, or any other variants thereof are intended to cover non-exclusive inclusion so that a process, method, article, or apparatus that includes a series of elements not only includes these very elements, but may also include other elements not expressly listed, or also include elements inherent to this process, method, article, or apparatus. Without being subject to further limitations, an element defined by a phrase “including . . . ” does not exclude presence of other identical elements in the process, method, article, or apparatus that includes the element.

The embodiments of the present disclosure are described above with reference to the accompanying drawings, but the present disclosure is not limited to the foregoing specific implementations. The foregoing specific implementations are merely illustrative and nonrestrictive. Under the guidance of the present disclosure, a person of ordinary skill in the art can also make many forms without departing from the scope of protection of the present disclosure and the claims, all of which are within the protection of the present disclosure.

What is claimed is:

1. A battery, comprising a battery cell, an electrolyte solution, and an aluminum-plastic film, wherein the aluminum-plastic film comprises an upper film and a lower film disposed opposite to each other, the upper film and the lower film are connected to form an accommodating cavity, and the battery cell and the electrolyte solution are disposed in the accommodating cavity; and
the electrolyte solution comprises a non-aqueous organic solvent, an additive, and a lithium salt, the lithium salt comprises lithium hexafluorophosphate and lithium bis(fluorosulfonyl)imide.

2. The battery according to claim 1, wherein a sealing edge is formed at a position at which the upper film and the lower film are connected, the sealing edge comprises a top sealing edge and a side sealing edge, and a relationship among a content of lithium hexafluorophosphate, a content of lithium bis(fluorosulfonyl)imide, a width of the top sealing edge, and a width of the side sealing edge is:
$$\frac{{A}_{1} - {A}_{2}}{min ( {W}_{1} , {W}_{2} )} \leq {x}_{1} ,$$
wherein A₁ is a mass fraction of lithium hexafluorophosphate in the electrolyte solution, A₂ is a mass fraction of lithium bis(fluorosulfonyl)imide in the electrolyte solution, W₁ is the width of the top sealing edge, W₂ is the width of the side sealing edge, and x₁ is a constant not greater than 0.2.

3. The battery according to claim 2, wherein x₁ is a constant not greater than 0.05.

4. The battery according to claim 2, wherein a relationship among the width of the top sealing edge, the width of the side sealing edge, and a minimum sealing strength of the sealing edge is:
$$L = {x}_{2} + {x}_{3} \times min ( {W}_{1} , {W}_{2} ) ,$$
wherein L is the minimum sealing strength of the sealing edge, x₂ is 16.45, and x₃ is 14.12.

5. The battery according to claim 2, wherein a relationship among the content of lithium hexafluorophosphate, the content of lithium bis(fluorosulfonyl)imide, and a minimum sealing strength of the sealing edge is:
$$\frac{{A}_{1} - {A}_{2}}{L} \leq {x}_{4} ,$$
wherein L is the minimum sealing strength of the sealing edge, and x₄ is a constant not greater than 0.006.

6. The battery according to claim 5, wherein x₄ is a constant not greater than 0.003.

7. The battery according to claim 1, wherein a relationship between a content of lithium hexafluorophosphate and a content of lithium bis(fluorosulfonyl)imide comprises:
$${A}_{1} + {A}_{2} \geq {x}_{5} ,$$
wherein A₁ is a mass fraction of lithium hexafluorophosphate in the electrolyte solution, A₂ is a mass fraction of lithium bis(fluorosulfonyl)imide in the electrolyte solution, and x₅ is 12%.

8. The battery according to claim 1, wherein a relationship between a content of lithium hexafluorophosphate and a content of lithium bis(fluorosulfonyl)imide comprises:
$${A}_{1} - {A}_{2} \leq {x}_{6} ,$$
wherein A₁ is a mass fraction of lithium hexafluorophosphate in the electrolyte solution, A₂ is a mass fraction of lithium bis(fluorosulfonyl)imide in the electrolyte solution, and x₆ is 17%.

9. The battery according to claim 7, wherein the relationship between the content of lithium hexafluorophosphate and the content of lithium bis(fluorosulfonyl)imide further comprises:
$$\frac{{A}_{2}}{{A}_{1}} \geq {x}_{7} ,$$
wherein x₇ is 0.01.

10. The battery according to claim 8, wherein the relationship between the content of lithium hexafluorophosphate and the content of lithium bis(fluorosulfonyl)imide further comprises:
$$\frac{{A}_{2}}{{A}_{1}} \geq {x}_{7} ,$$
wherein x₇ is 0.01.

11. The battery according to claim 2, wherein A₁ ranges from 0.1% to 30%, and A₂ ranges from 0.1% to 30%.

12. The battery according to claim 2, wherein W₁ is not less than a preset value Y, and Y meets:
$$Y = \frac{( {x}_{8} + {x}_{9} \times H ) \times {W}_{2}}{{x}_{10} - {x}_{11} \times H + {W}_{2}} ,$$
wherein H is a thickness of the sealing edge, and x₈, x₉, x₁₀, and x₁₁ are all constants.

13. The battery according to claim 12, wherein x₈ ranges from 0.001 to 0.01, x₉ ranges from 0.001 to 0.01, x₁₀ ranges from 0.001 to 0.01, and x₁₁ ranges from 0.001 to 0.01.

14. The battery according to claim 12, wherein H ranges from 210 μm to 270 μm.

15. The battery according to claim 2, wherein W₁ ranges from 0.8 mm to 10 mm.

16. The battery according to claim 2, wherein W₂ ranges from 4.1 mm to 10 mm.

17. The battery according to claim 12, wherein Y meets:
$$Y = \frac{( 0.0092721 + 0.0039685 \times H ) \times {W}_{2}}{0.0062564 - 0.0194843 \times H + {W}_{2}} .$$

18. The battery according to claim 1, wherein the additive comprises styrene.

19. The battery according to claim 18, wherein a mass fraction of styrene in the electrolyte solution ranges from 0.1% to 1%.

20. The battery according to claim 1, wherein the battery cell comprises a positive electrode plate, a negative electrode plate, and a separator.
